(19) United States
(12) Patent Application Publication
(10) Pub. No.: US 2018/0160823 A1
(43) Pub. Date: Jun. 14, 2018

(54) TRAY WITH LEVEL INDICATION

(71) Applicant: WEGMANN automotive GmbH & Co. KG, Veitshochheim (DE)

(72) Inventor: Michael Graber, Hettstadt (DE)

(21) Appl. No.: 15/892,091

(22) Filed: Feb. 8, 2018

Related U.S. Application Data
(63) Continuation of application No. PCT/EP2016/069040, filed on Aug. 10, 2016.

(30) Foreign Application Priority Data
Aug. 11, 2015 (EP) 15180562.9

(51) Int. Cl. A47F 1/12; A47F 5/00; A47F 7/28; G09F 11/00

(52) U.S. Cl. CPC A47F 1/126; A47F 5/0037; G09F 2007/1856; G09F 11/00; A47F 7/28

(57) ABSTRACT

The invention relates to a shelfing rack for storing articles like balancing weights, preferably in boxes. The shelfing system or rack is designed to enable an easy extraction of the balancing weights out of their boxes. It includes a plurality of trays, each holding multiple boxes. A slider together with an indicator contact the boxes. In case that a box is the last one in the tray, a requirement display indicates that the tray is nearly empty.

### CROSS-REFERENCE TO RELATED APPLICATIONS

This application is a continuation of pending International Application No. PCT/EP2016/069040 filed on Aug. 10, 2016 and now published as WO 2017/025563, which designates the United States and claims priority from the European Application No. 15180562.9 filed on Aug. 11, 2015 now granted as EP3130259. The disclosure of each of the above-identified patent applications is incorporated herein by reference.

### BACKGROUND

### 1. Field of the Invention

The invention relates to a tray, a shelf, and a storage rack configured to store articles (preferably balancing weights). The storage rack holds a plurality of articles, preferably small parts, such as balancing weights, tire valves, TPMS parts and accessories or other components contained in boxes. The storage rack is designed to enable an easy extraction of the balancing weights out of their transport packaging. In case of an empty package, the package can be removed and a new package will be supplied automatically. In the case that the package is the last one available, an indicator appears which hints the user that only one article for example one box of balancing weights is left.

### 2. Description of Relevant Art

A shelfing system for supplying boxes is disclosed in DE 10 2012 024 994 A1. The shelfing system has a loading spring with a marker that may be seen through a small window in the front cover and that indicates whether the shelf is empty.

US 2014/0124463 A1 discloses a space-saving manual shelf management system for storing groceries, which has a puller device over the length of the entire shelf which needs to be accessible at all times, even when the shelf is full of products.

WO 2009/156599 A1 discloses a device for displaying products that includes at least one longitudinal supporting element and at least one longitudinal guide element in parallel mounted on a common frame comprising a securing element.

U.S. Ser. No. 10/702,987 A discloses a tray for displaying merchandise. The tray is designed as a container and being suitable to be placed on the shelfs in stores.

### SUMMARY

The embodiments provide a simple and robust tray, shelf, and/or storage rack with an indicator configured to indicate that only one or another predetermined number of articles is left or present in the tray, shelf, and/or storage rack. An article may be a box for small parts, for example balancing weights. The box is designed to present and make such article(s), for example balancing weights, available to an operator.

In an embodiment, a tray configured to store articles includes a base (preferably having an elongated rectangular shape with a left and a right broadside), a front side, and a rear side. The front side may be configured to serve for presentation of articles stored in the tray. The base preferably has one or two lateral guides at one or both of the broadsides. The rear side may be open for refilling of articles. The tray includes a slider which is supported by the base of the tray. The slider may be guided moveably in at least one guiding track, which may be part of the base and/or by at least one of the lateral guides. The slider may have a slider plate configured to slide on the base. The slider plate preferably has a rectangular shape. From the slider plate extends a driving pin or plate configured to contact and/or drive at least one of the articles. The slider plate may have a protrusion which may interface with the guiding track. It is preferred if the tray has a stop or stopper at the front side, which is configured to limit the movement of the slider in the tray.

The slider has at least one indicator affixed thereto (which indicator may be dimensioned as a tongue or a rod oriented towards the front side and preferably approximately parallel to the base). The tongue or the rod may be made out of metal or plastic material. The indicator, which may be a tongue or rod, may have at least one marking area which may have or carry some marking indicia. The marking indicia may possess specific colors and/or may have a bar code or a serial number or another inscription or a color marking.

The base of the tray may include rolls or ball bearings configured to support, and/or enable an improved movability of, the articles in the tray and/or the slider that may be guided by the roles or the ball bearings too. The tray has at least one opening at the front side of the tray (which opening preferably is a slot). Such opening is dimensioned to operably correspond to the indicator.

The indicator has a corresponding length so that it may extend or protrude from the opening at the front side, in a way that the so-protruded indicator is visible from the front side, when the slider is positioned close to the front side. (In one specific non-limiting case, when the indicator is directly affixed to the slider, the position of the slider close to the front side may be defined when the distance between the slider and the front side is shorter or equal to the length of the indicator. In another non-limiting case, when the indicator is affixed to the slider via an intermediate member separating the indicator from the slider, the position of the slider close to the front side may be defined when the distance between the slider and the front side is shorter or equal to the combined lengths of the indicator and the intermediate member). The length of the indicator may be equal to or greater than the width of one article which is stored in the tray. Such indicator may extend only when the slider is in a position close to the front side. In a preferred embodiment, the indicator has a length judiciously defined to make the indicator visible if only one article (one box of balancing weights) is left or present in the tray. The indicator may also have a length that is larger than a dimension of one or more articles, to provide an indication if one or more articles are remaining or present in the tray.

In a further embodiment, at least one tray may be part of a shelf which may be part of a storage rack. The shelf may have a corresponding frame where a plurality of trays may be mounted or hooked and secured. The shelf may also be a plate which may furthermore be subdivided in at least one or a plurality of trays with at least two lateral guides. The material of the shelf may be wood, metal, plastic, or a combination thereof. The shelf may be attached perpendicularly to the frame or at an inclination angle with respect to the frame. The tray may be inclined at a chosen inclination angle (with respect to a chosen plane such as the horizontal plane, for example) such that cause gravity to generate a force applied to the slider and directed to the front side of the tray. Preferably the inclination angle has a range from about 1° to about 45° to enable a movement of the articles to the front side by gravity. There may further be a means configured to generate force applied to or engaging the slider and directed towards the front side. Such a means may be a spring. The slider may be spring loaded by such a spring towards the front side of the tray. The tray(s) may be attached to the frame with screws, rivets or welding. The shelf preferably has at least one stop or stopper on the front side (the front side is preferably identified at the side where the user may pick the articles such as boxes or balancing weights).

The storage rack may further comprise at least one shelf. It may have a frame extending in an upward direction, which frame may be made out of metal, (such as aluminum or steel, for example). The frame may be dimensioned to have a rectangular, round, or oval shape. The frame may have a round or square or oval pattern contour. The frame may be structured as a closed frame on a base plate with or with at least one pedestal and a base plate.

### BRIEF DESCRIPTION OF THE DRAWINGS

In the following, the invention will be described by way of example, without limitation of the general inventive concept, on examples of embodiment and with reference to the drawings.

FIG. 1 shows a preferred embodiment of the tray.

FIG. 2 shows a shelf with trays.

FIG. 3 shows a rack system with several shelves and trays.

FIG. 4 shows a preferred embodiment of rack system in a side view.

FIG. 5 shows yet another related embodiment of the tray.

FIG. 6 shows another embodiment of the tray.

The implementations of the idea of the invention can be variously modified and take alternative forms. Specific embodiments are shown and discussed below by way of examples and with the help of the drawings. It should be understood, however, that the drawings and the presented detailed description are not intended to limit the invention to any particular disclosed form, but on the contrary, the scope of the intention is intended to cover all modifications, equivalents, and alternatives falling within the spirit and scope of the idea of the present invention as defined by the appended claims.

### DETAILED DESCRIPTION

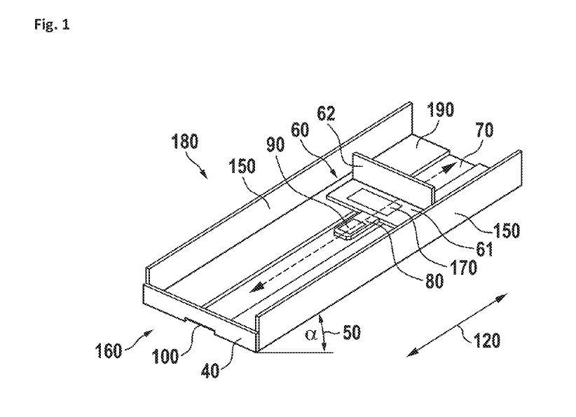

FIG. 1 discloses a single tray 180. The tray 180 preferably has a planar base 190 with an elongated rectangular shape having two broadsides 120, a front side 160, and a rear side. Preferably, the base 190 includes a lateral guide 150 on each side in the broadside 120. Furthermore, the tray 180 may include a stop 40 at the front side 160, and a slider 60 that may be structured to be guided by a track 70. The slider 60 may have a slider plate 61 configured to glide on the base 190. The slider plate 61 preferably has a rectangular shape. From the slider plate extends a driving plate 62. The slider plate 61 may have a protrusion, which may interface with the guiding track 70. The slider 60 further includes an indicator 80 (which may be a dimensioned to resemble a tongue, and which preferably is attached to the slider 60 most preferably in parallel to the plane of the base 190). The front side 160 has an opening 100 configured such that the indicator 80 may extend through the opening 100 only when the slider 60 is in a position close to (approaching) the front side. The slider 60 and/or the indicator 80 preferably has a marking area 90, 170. The marking may have a specific color and/or may have or carry a bar code or a serial number or another inscription or a color marking. Notably, each stop 40 has an opening 100 for the indicator 80 (which may be a tongue). There may be present a spring, with which the slider 60 maybe be loaded or biased towards the front side 160.

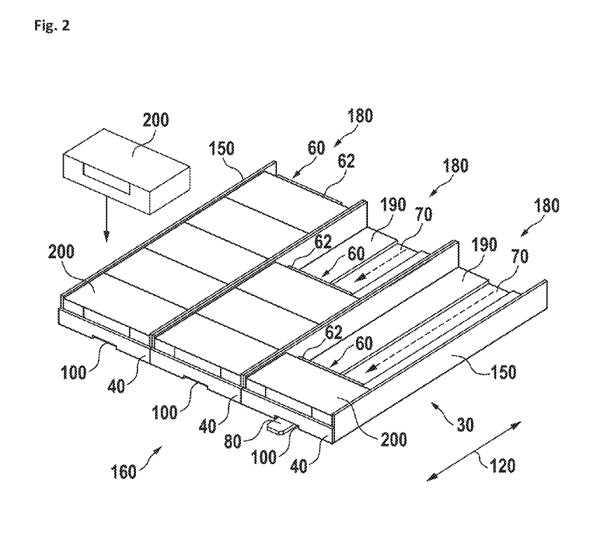

FIG. 2 discloses a shelf 30, which is divided into several trays 180. Each tray 180 has a slider 60 (which is guided by a track 70) and each slider 60 has an indicator 80 (which may be configured to resemble a tongue). The slider 60 may have a slider plate 61 configured to slide on the base 190. The slider plate 61 preferably has a rectangular shape. From the slider plate 61 extends a driving plate 62 configured to contact and/or drive or move, in operation, at least one of the articles 200. The slider plate 61 may have a protrusion that may interface with the guiding track 70. Each tray 180 has a stop 40, preferably at the front side. Each stop 40 has an opening 100 for the indicator 80. The indicator 80 may have a length equal to or greater than the width of one article 200, which is stored in the tray so that the indicator becomes visible if only one article 200 left in the tray 180. The indicator 80 may also have a length that is larger than a dimension of one or more articles 200, to provide an indication if one or more articles 200 are remaining in the tray.

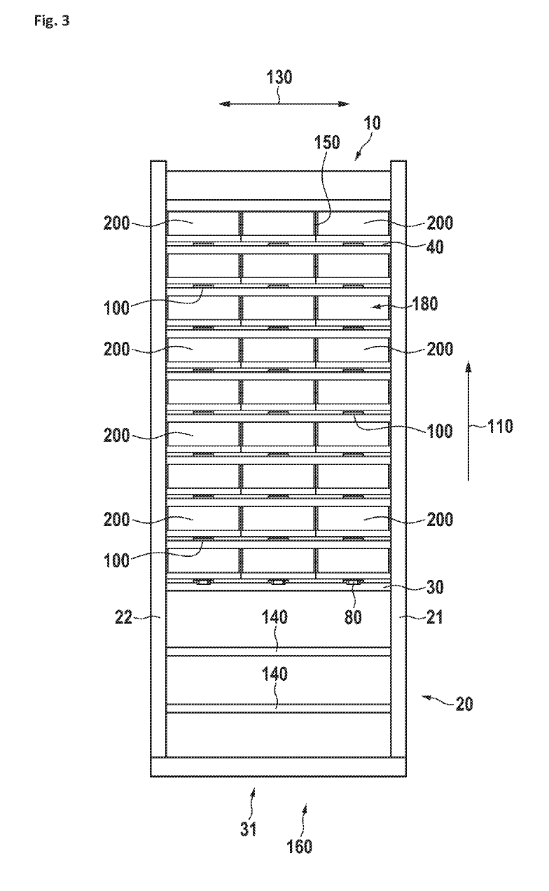

FIG. 3 shows a preferred embodiment of a storage rack 10 in front view. The embodiment comprises a frame 20 with two parallel pedestals 21, 22 are arranged in an upward direction 110 and mounted to a base plate 31 in the direction of the longitudinal side 130. The frame 20 is preferably made of metal.

The storage rack 10 further includes several shelves 30, which are attached to the frame 20, and extra shelves 140 for storage space for storing, in one application, tools or documents or other equipment. Each shelf 30 is divided into several trays 180 by lateral guides 150. Each tray has a stop 40 with an opening 100, preferably disposed at the front side 160.

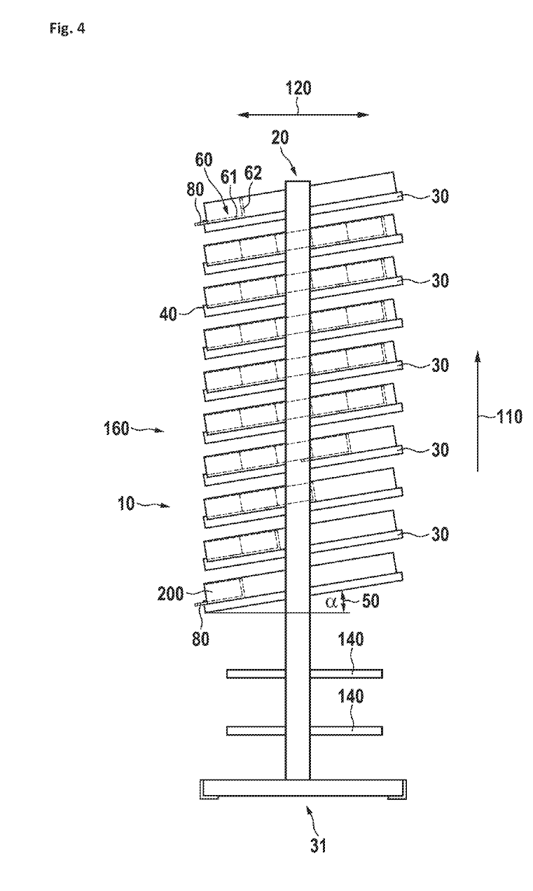

FIG. 4 discloses a shelfing system 10 in side view with several shelves 30 and extra shelves 140 for storage space for storing for example tools or documents, adhesive balancing weights or other equipment. Each shelf 30 preferably has an inclination angle 50 of approximately 10 degrees.

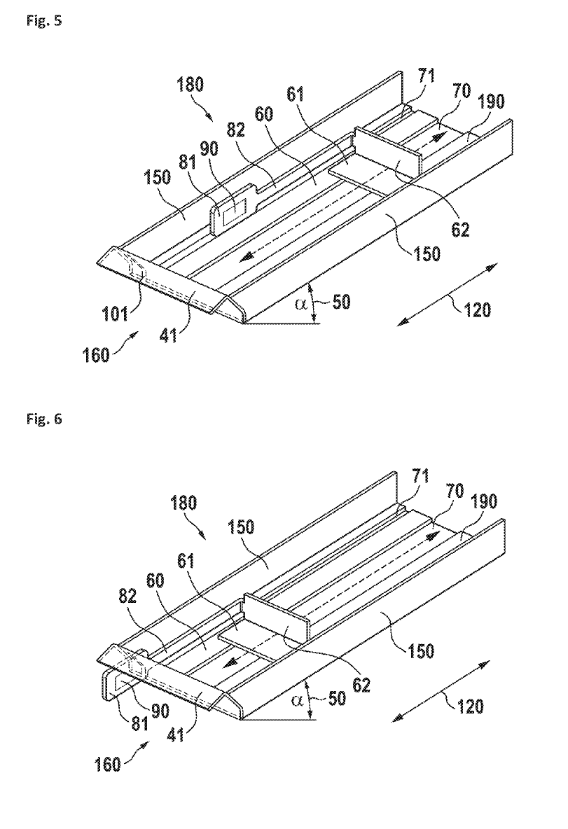

FIG. 5 discloses a single tray 180 similar to that of FIG. 1. The tray 180 has an indicator 81 the plane of which is oriented vertically (in a plane substantially perpendicular to the plane of the base 190. The indicator 81 is aligned, via a tongue 82, to the driving plate 62. The indicator 81 may be guided in a separate guiding track 71. The stop 41 may have a profiled contour.

FIG. 6 discloses the single tray 180 of FIG. 5 in a different operational position. Here, the slider 60 is shown in a position in which the indicator 81 protrudes through an opening 101 in the stop 41. (The opening 101 may have a vertical orientation).

It will be appreciated to those skilled in the art having the benefit of this disclosure that this invention is believed to provide a tray, a shelf and a storage rack configured to store articles preferably balancing weights. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

10 storage rack
20 frame
21 first pedestal
22 second pedestal
30 shelf
31 base plate
40 stop
41 stop
50 inclination angle
60 slider
61 slider plate
62 driving plate
70 guiding track
71 guiding track
80 indicator
81 indicator
82 tongue
90 marking area
100 opening/slot
101 opening/slot
110 upward direction
120 broadside
130 longitudinal side
140 storage space
150 lateral guide
160 front side
170 marking area
180 tray
190 base
200 box/article

1. A tray configured to store articles, the tray having a base and a front side for presentation of articles, the tray comprising:
a slider, moveably arranged in a guiding track in said base,
a stop at the front side limiting the movement of the slider,
an indicator is fixed to the slider and oriented towards the front side, and
wherein
the front side has an opening through which the indicator extends only when the slider is in a position close to the front side.

2. A tray according to claim 1, wherein the indicator has at least one marking area.

3. A tray according to claim 2, wherein the at least one marking area has a bar code.

4. A tray according to claim 2, wherein the at least one marking area has a color marking.

5. A tray according to claim 1, wherein the base of the tray has rolls or ball bearings configured to support at least one of the articles and the slider.

6. A tray according to claim 1, wherein the tray includes means configured to generate a force applied to the slider and directed to the front side.

7. A tray according to claim 6, wherein the means configured to generate a force to the slider is a spring.

8. A tray according to claim 1, wherein the tray is configured to be inclined at an inclination angle with respect to a chosen plane to cause a force, generated by gravity, to apply to the slider and be directed to the front side.

9. A tray according to claim 1, wherein the opening comprises a slot.

10. A tray according to claim 1, wherein the tray has at least one lateral guide.

11. A tray according to claim 1, wherein a length of the slider and a length of the indicator are larger than one or multiples of a length of an article chosen to be stored in the tray.

12. A shelf comprising at least one tray according to claim 1.

13. A storage rack comprising at least one shelf according to claim 12.

14. A storage rack according to claim 13, further comprising a frame, wherein the shelf is disposed at an inclination angle with respect to the frame.

15. A storage rack according to claim 13, wherein the storage rack comprises a frame with a rectangular shape.
